(19) United States
(12) Patent Application Publication
(10) Pub. No.: US 2003/0048485 A1
(43) Pub. Date: Mar. 13, 2003

(54) Cost management system

(76) Inventor: Honami Shiraishi, Yamatokouriyama-shi (JP)

Correspondence Address: BIRCH STEWART KOLASCH & BIRCH, PO BOX 747, FALLS CHURCH, VA, 22040-0747, US

(21) Appl. No.: 10/238,582

(22) Filed: Sep. 11, 2002

(30) Foreign Application Priority Data
Sep. 11, 2001 (JP) 2001-274494

(51) Int. Cl. H04N 1/00

(52) U.S. Cl. 358/434

(57) ABSTRACT

A cost management system operates with a reduced burden on management personnel as a result of the management information on individual communication terminal devices being concentrated in an information processing device by way of a communication network. To achieve this, the cost management system includes a personal computer and a plurality of facsimile devices connected together by way of a network. The personal computer receives data on the amounts of expendables consumed and the communication charges from the facsimile devices, and generates, based on the thus received data, management information on expendables consumption, communication charges, and the like. Thus, the operating costs of the facsimile devices are managed in a centralized manner.

### BACKGROUND OF THE INVENTION

1. Field of the Invention

The present invention relates to a cost management system including an information processing device and one or more communication terminal devices connected together by way of a communication network.

2. Description of the Prior Art

In one conventional form of communication system, a communication terminal device such as a facsimile device that communicates with another communication terminal device by way of a public network is connected to an information processing device such as a personal computer (hereinafter abbreviated to “PC”) by way of a communication network such as a LAN (local area network). The costs of expendables of such communication terminal devices are usually managed on a collective basis by keeping track of the amounts or costs of expendables consumed in all the communication terminal devices installed in a given area. That is, the amounts or costs of expendables consumed in each communication terminal device are not monitored or managed on an individual basis. The same is true with communication charges and fees.

Obviously, more accurate and detailed cost management is possible by monitoring and managing the amounts and costs of expendables consumed in each communication terminal device on an individual basis. However, for management personnel to do this in a conventional communication system, they need to operate terminal devices, or devices that display the status of communication terminal devices, individually to obtain the necessary information. This imposes on the management personnel a burden that increases in proportion to the number of communication terminals devices to be managed.

For example, Japanese Patent Application Laid-Open No. H3-176179 discloses a communication terminal device that generates and prints out management information on expendables.

However, if the communication terminal device disclosed in Japanese Patent Application Laid-Open No. H3-176179 mentioned above is applied to the communication system described above, for management personnel to obtain management information on expendables consumed in a given communication terminal device as described above, they need to go over to that communication terminal device and perform predetermined key operation on it to print out management information on expendables. This requires too much time and trouble.

### SUMMARY OF THE INVENTION

An object of the present invention is to provide a cost management system that operates with a reduced burden on management personnel as a result of the management information on individual communication terminal devices being concentrated in an information processing device by way of a communication network. Another object of the present invention is to provide a communication terminal device and an information processing device for use in such a cost management system.

To achieve the above objects, according to one aspect of the present invention, a cost management system including an information processing device and one or more communication terminal devices connected together by way of a communication network is characterized in that the information processing device receives data relating to an expendable from at least one of the communication terminal devices and generates, based on the thus received data, management information on the expendable.

By concentrating the management information on individual communication terminal devices in an information processing device by way of a communication network in this way, it is possible to eliminate the need to equip the individual communication terminal devices with the function of expendables management. This helps minimize the increase in the costs of the communication terminal devices. Moreover, it is possible to eliminate the need for management personnel to collect data on expendables on individual communication terminal devices. This helps alleviate the burden on the management personnel.

The management information may be the amount or cost of the expendable consumed. The communication terminal device concerned may be a facsimile device, network-ready facsimile device, image forming device, or network-ready image forming device.

According to another aspect of the present invention, a cost management system including an information processing device and one or more communication terminal devices connected together by way of a communication network is characterized in that the information processing device receives data relating to communication from at least one of the communication terminal devices and generates, based on the thus received data, management information on the communication.

By concentrating the management information on individual communication terminal devices in an information processing device by way of a communication network in this way, it is possible to eliminate the need to equip the individual communication terminal devices with the function of communication management. This helps minimize the increase in the costs of the communication terminal devices. Moreover, it is possible to eliminate the need for management personnel to collect data on communication on individual communication terminal devices. This helps alleviate the burden on the management personnel.

The management information may be the charge of communication. The communication terminal device concerned may be a facsimile device, network-ready facsimile device, network-ready image forming device, or telephone set.

The information processing device or the communication terminal device concerned may output the management information by displaying it or printing it out. The information processing device or the communication terminal device concerned may output a history of the management information.

The information processing device may calculate the difference between the management information and a predetermined value so that the information processing device or the communication terminal device concerned may output the thus calculated difference. This helps further alleviate the burden on the management personnel.

The information processing device may calculate the differences between the management information and a predetermined value so that, when the thus calculated difference is within a predetermined range, the information processing device or the communication terminal device concerned may output a warning.

According to another aspect of the present invention, an information processing device connected to one or more communication terminal devices by way of a communication network is characterized in that it receives data relating to an expendable from at least one of the communication terminal devices, generates, based on the thus received data, management information on the expendable, and outputs the thus generated management information. The management information may be the amount or cost of the expendable consumed.

According to another aspect of the present invention, an information processing device connected to one or more communication terminal devices by way of a communication network is characterized in that it receives data relating to communication from at least one of the communication terminal devices, generates, based on the thus received data, management information on the communication, and outputs the thus generated management information. The management information may be the charge of communication.

In contrast to these information processing devices, a communication terminal device connected to such an information processing device is characterized in that it transmits data on an expendable to the information processing device.

The communication terminal device may be a facsimile device, network-ready facsimile device, image forming device, or network-ready image forming device.

Alternatively, a communication terminal device connected to such an information processing device is characterized in that it transmits data on communication to the information processing device.

The communication terminal device may be a network-ready facsimile device, network-ready image forming device, or telephone set.

### BRIEF DESCRIPTION OF TILE DRAWINGS

This and other objects and features of the present invention will become clear from the following description, taken in conjunction with the preferred embodiments with reference to the accompanying drawings in which:

FIG. 1 is a block diagram showing the configuration of the cost management system of a first embodiment of the invention;

FIG. 2 is a block diagram showing the configuration of the cost management system of a second embodiment of the invention;

FIG. 3 is a flow chart showing the operation of the PC in Example 1;

FIG. 4 is a diagram showing an image indicating the amounts of expendables consumed in Example 1;

FIG. 5 is a flow chart showing another example of the operation of the PC in Example 1;

FIG. 6 is a diagram showing an image indicating the results of comparison between the amounts of expendables consumed and predetermined values in Example 1;

FIG. 7 is a flow chart showing still another example of the operation of the PC in Example 1;

FIG. 8 is a diagram showing an image indicating the results of comparison between the amounts of expendables consumed and predetermined values together with a warning in Example 1;

FIG. 9 is a flow chart showing the operation of the PC in Example 2;

FIG. 10 is a diagram showing an image indicating the costs of expendables consumed in Example 2;

FIG. 11 is a diagram showing an image indicating the results of comparison between the costs of expendables consumed and their respective budgets in Example 2;

FIG. 12 is a diagram showing an image indicating the results of comparison between the costs of expendables consumed and their respective budgets together with a warning in Example 2;

FIG. 13 is a flow chart showing the operation of the PC in Example 3;

FIG. 14 is a diagram showing an image indicating the communication charge in Example 3;

FIG. 15 is a diagram showing an image indicating the results of comparison between the communication charge and its budget in Example 3; and

FIG. 16 is a diagram showing an image indicating the results of comparison between the communication charge and its budget together with a warning in Example 3,

### DESCRIPTION OF THE PREFERRED EMBODIMENTS

Hereinafter, as embodiments of the present invention, examples will be described of the configuration of a cost management system including an information processing device and one or more communication terminal devices connected together by way of a communication network. Here, a communication network denotes any type of network that permits the communication terminal devices and the information processing device to communicate with each other, specifically, any network achieved by way of a telephone network, the Internet, a LAN, a USB cable, or the like.

### First Embodiment

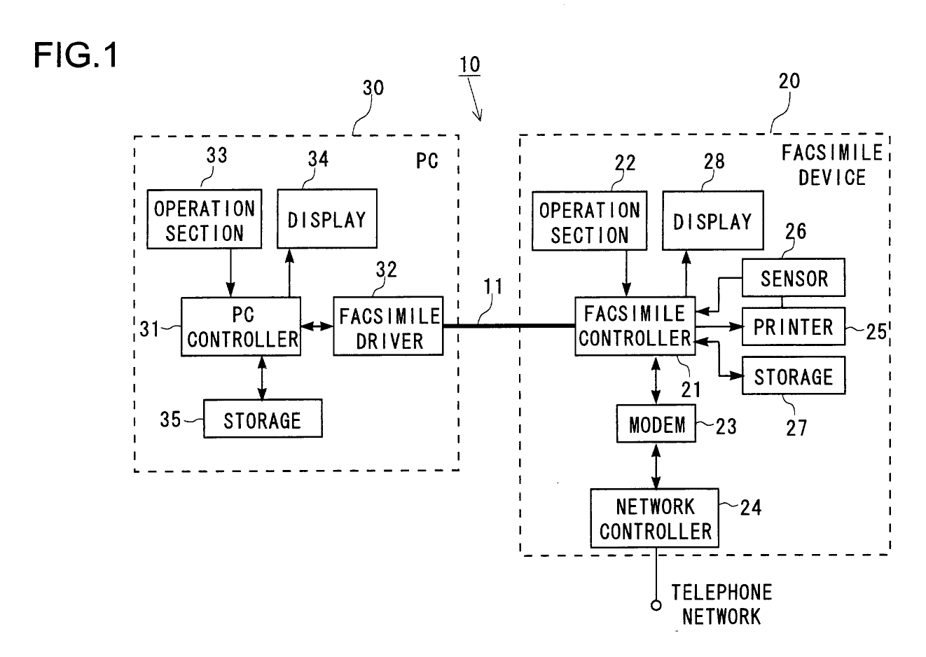

FIG. 1 is a block diagram showing the configuration of the cost management system of a first embodiment of the invention. This cost management system 10 includes a PC 30 and a facsimile device 20 connected together by way of a USB 11.

The facsimile device 20 is provided with a facsimile controller 21 for controlling the various blocks constituting the facsimile device 20 and controlling communication with the PC 30, an operation section 22 such as keys or a touch screen operated by the user for data entry, a modem 23 for modulating to-be-transmitted image data and demodulating received image data, a network controller 24 for establishing connection with a telephone network, a printer 25 for printing image data on recording paper by using a developer such as toner or ink, a sensor 26 for detecting the amounts of consumed expendables such as toner or ink and recording paper, a storage 27 such as a hard disk device for storing data relating to expendables and data relating to communication, and a display 28 for displaying images.

Here, the data relating to expendables includes the amounts of consumed expendables (toner or ink, recording paper, etc.) detected by the sensor 26, the dates on which they were supplied or replaced, and other data. On the other hand, the data relating to communication includes the dates and times when image data was transmitted or received, the communication partners with which data was exchanged, and the duration of each communication session, and other data.

The PC 30 is provided with a PC controller 31 for controlling the various blocks constituting the PC 30, a facsimile driver 32 connected to the facsimile device 20 by way of the USB 20, an operation section 33 such as a keyboard operated by the user for data entry, a display 34 for displaying images, and a storage 35 for storing data and the like received from the facsimile device 20. In this cost management system 10 configured as described above, the PC 30 manages the operating costs of the facsimile device 20.

### Second Embodiment

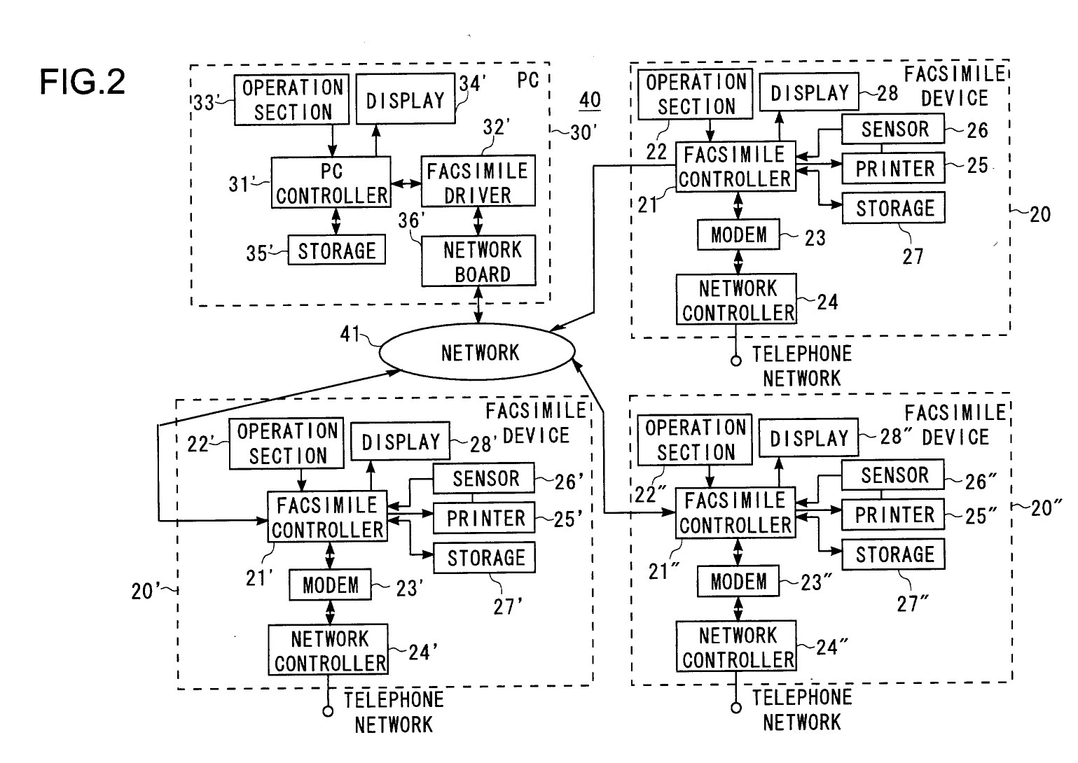

FIG. 2 is a block diagram showing the configuration of the cost management system of a second embodiment of the invention. This cost management system 40 includes a PC 30′ and three facsimile devices 20, 20′, and 20″ connected together by way of a network 41 such as a LAN. This embodiment is largely the same as the first embodiment except that the PC 30′ is provided additionally with a network board 36′ for establishing connection with the network 41, and therefore no detailed explanations thereof will be given. In this cost management system 40 configured as described above, the PC 30′ manages the operating costs of the facsimile devices 20, 20′, and 20″ on a collective basis.

In the first and second embodiments, the facsimile devices 20, 20′, and 20″ are provided with largely the same blocks as those constituting conventional facsimile devices, and thus can be produced with almost no increase in their costs. Hereinafter, practical examples of how management is achieved in the cost management system of the second embodiment will be described. It is to be understood that the examples described below apply to the first embodiment as well.

### EXAMPLE 1

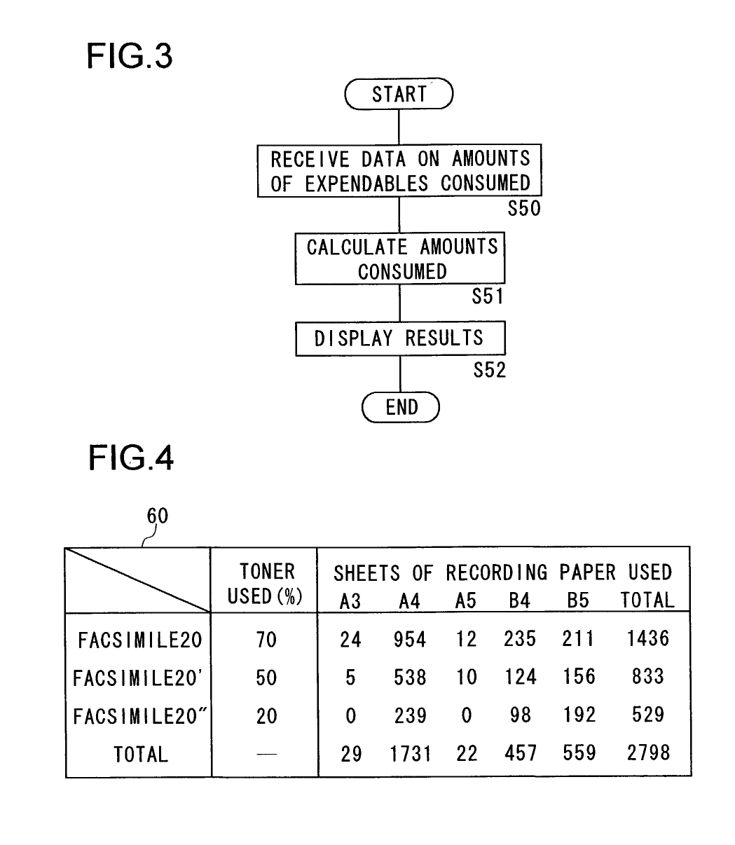

In Example 1, the cost management system 40 manages the amounts of expendables consumed. FIG. 3 shows a flow chart of the operation of the PC 30′. First, in step S50, the PC 30′ receives data relating to the amounts of consumed expendables from the facsimile device 20. Then, in step S51, based on the received data, the PC controller 31′ calculates the amounts of expendables consumed. Then, in step S52, the calculated results are displayed on the display 34′. In similar manners, the amounts of expendables consumed in the facsimile machines 20′ and 20″ are calculated and displayed together.

For example, in a case where the expendables monitored by the sensor 26 in the facsimile device 20 are toner and recording paper, the amount of toner consumed and the numbers of sheets of recording paper of different sizes consumed are stored in the storage 27. The PC 30′ receives the data stored in the storage 27, and displays it on the display 34′ together with the data received from the facsimile devices 20′ and 20″ in similar manners. FIG. 4 shows an image 60 displayed on the display 34′ to indicate the amounts of expendables consumed. The image 60 permits management personnel to manage on a collective basis management information such as the total and size-by-size numbers of sheets of recording paper consumed in the individual facsimile devices.

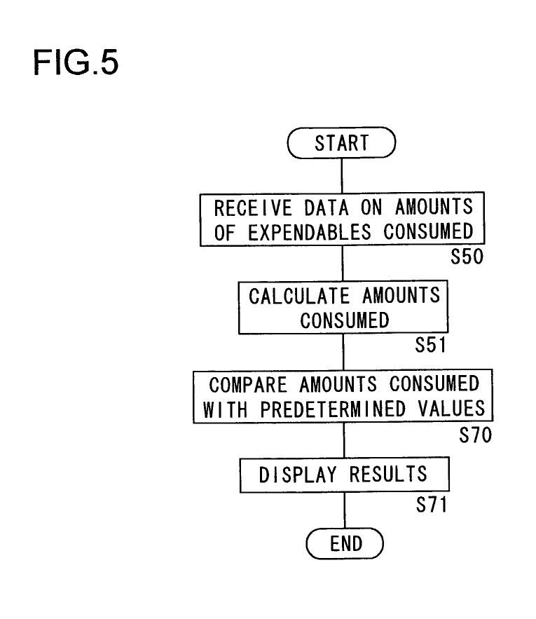

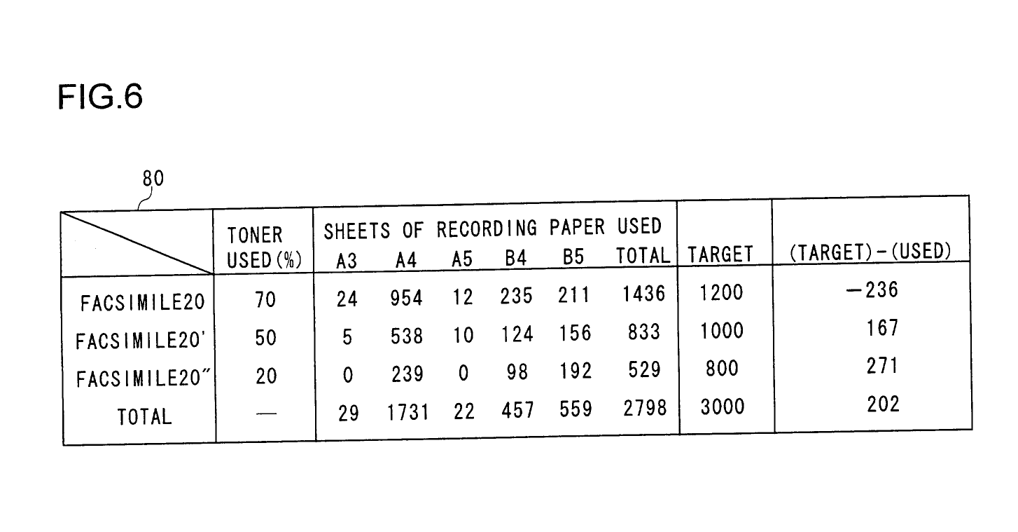

The amounts consumed may be compared with predetermined target values to display the differences. FIG. 5 shows a flow chart of the operation of the PC 30′ in that case. Here, steps S50 and S51 are the same as in FIG. 3. Then, in step S70, the amounts consumed are compared with predetermined values to calculate the differences, and then, in step S71, the results are displayed on the display 34′. FIG. 6 shows an image 80 displayed on the display 34′ to indicate the results of the comparison. The image 80 permits management personnel to manage on a collective basis management information such as whether the numbers of sheets of recording papers consumed are within target values or not.

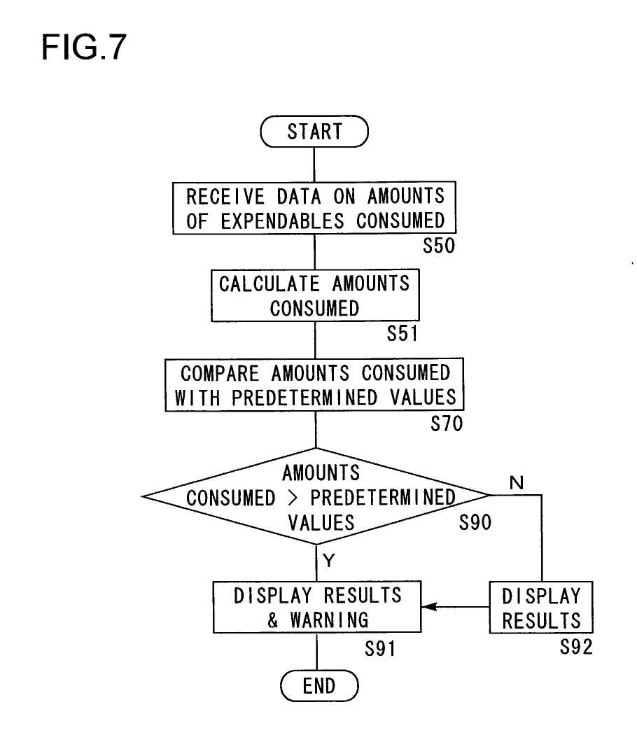

Alternatively, the amounts consumed may be compared with predetermined target values to output a warning when the amounts consumed have exceeded the target values. Here, as a means for outputting a warning, it is possible to display characters in a different color, or display or print a warning message, or sound the warning. FIG. 7 shows a flow chart of the operation of the PC 30′ in that case. Here, steps S50, S51, and S70 are the same as in FIG. 5. Then, in step S90, whether the amounts consumed have exceeded the target values or not is checked.

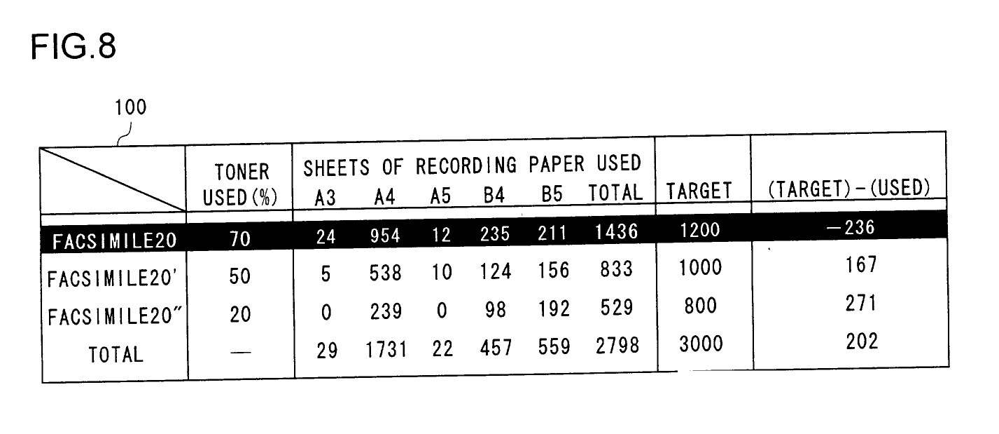

If, in step S90, the amounts consumed have exceeded the target values, then, in step S91, the results of the comparison are displayed and a warning is output. If, in step S90, the amounts consumed have not exceeded the target values, then, in step S92, the results of the comparison and other data are displayed on the display 34′. FIG. 8 shows an image 100 displayed on the display 34′ to indicate the comparison results and the warning. Here, the number of sheets of recording paper consumed in the facsimile device 20 has exceeded its target value, and therefore the relevant results are displayed in a reversed color as a warning. The image 100 permits management personnel to check at a glance whether the numbers of sheets of recording paper consumed are within target values or not.

### EXAMPLE 2

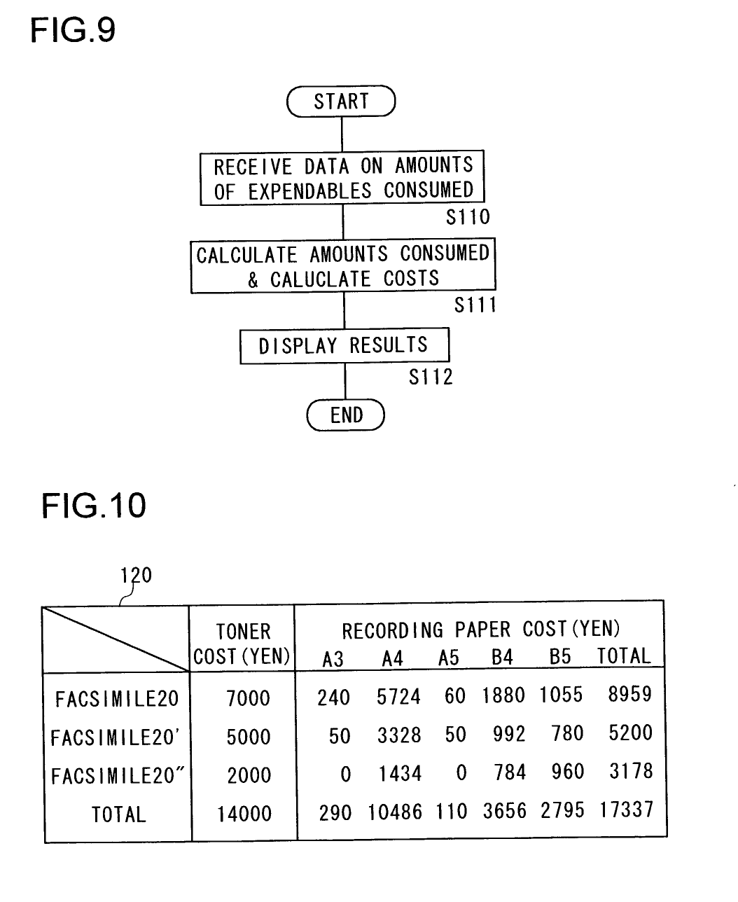

In Example 2, the cost management system 40 manages the costs of expendables. FIG. 9 shows a flow chart of the operation of the PC 30′. First, in step S110, the PC 30′ receives data relating to the amounts of consumed expendables from the facsimile device 20. Then, in step S111, based on the received data, the PC controller 31′ calculates the amounts of expendables consumed, and then multiplies them by the unit costs of the expendables. Then, in step S112, the calculated results are displayed on the display 34′. In similar manners, the costs of expendables consumed in the facsimile machines 20′ and 20″ are calculated and displayed together.

For example, in a case where the expendables monitored by the sensor 26 in the facsimile device 20 are toner and recording paper, the amount of toner consumed and the numbers of sheets of recording paper of different sizes consumed are stored in the storage 27. The PC 30′ receives the data stored in the storage 27, calculates the costs, and displays them on the display 34′ together with the costs calculated from the data received from the facsimile devices 20′ and 20″ in similar manners. FIG. 10 shows an image 120 displayed on the display 34′ to indicate the costs of expendables consumed. The costs indicated in the image 120 are based on the amounts consumed indicated in the image 60 shown in FIG. 4. The image 120 permits management personnel to manage on a collective basis management information such as the costs of toner, recording paper, etc. consumed in the individual facsimile devices.

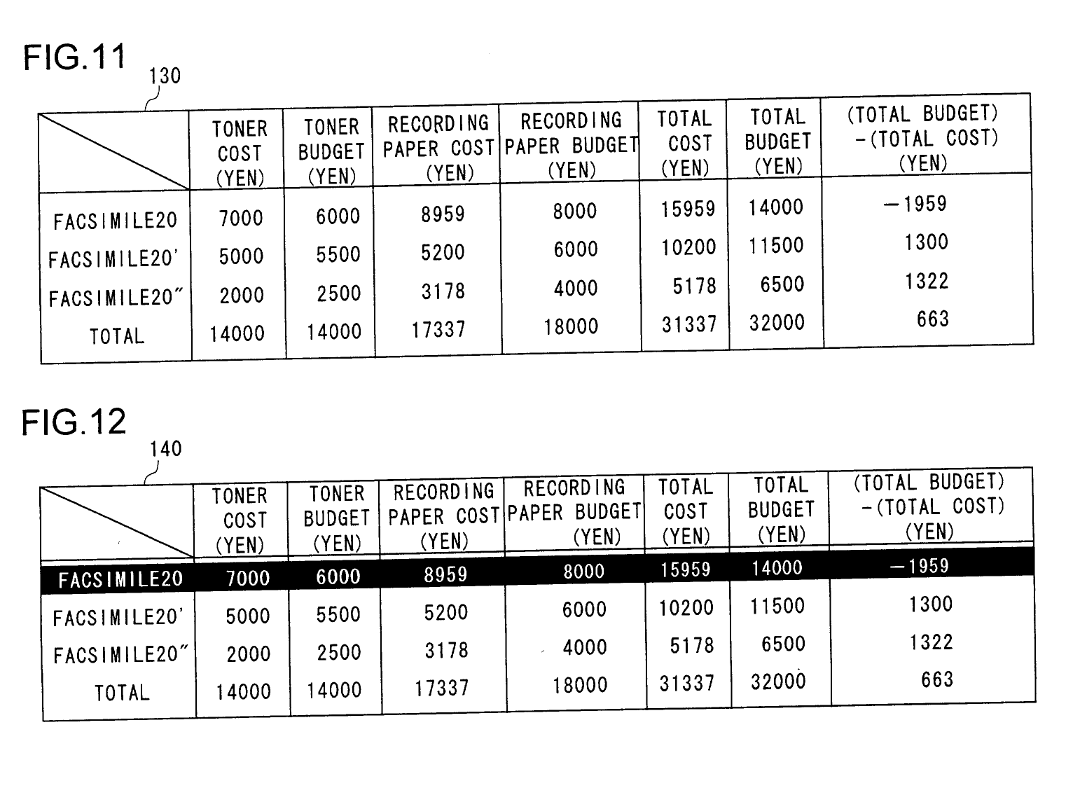

The actual costs calculated may be compared with previously made budgets to display the differences. FIG. 11 shows an image 130 displayed on the display 34′ to indicate the results of the comparison. The image 130 permits management personnel to manage on a collective basis management information such as whether the costs of expendables are within budgets or not.

Alternatively, the actual costs calculated may be compared with previously made budgets to output a warning as described in Example 1 when the actual costs have exceeded the budgets. FIG. 12 shows an image 140 displayed on the display 34′ to indicate the comparison results and the warning. Here, the operating costs of the facsimile device 20 have exceeded the budget for it, and therefore the relevant results are displayed in a reversed color as a warning. The image 140 permits management personnel to check at a glance whether the costs of expendables are within budgets or not.

Examples 1 and 2 described above deal with cases where facsimile devices are used as communication terminal devices. However, it is also possible to use instead network-ready facsimile devices, image forming devices, or network-ready image forming devices.

### EXAMPLE 3

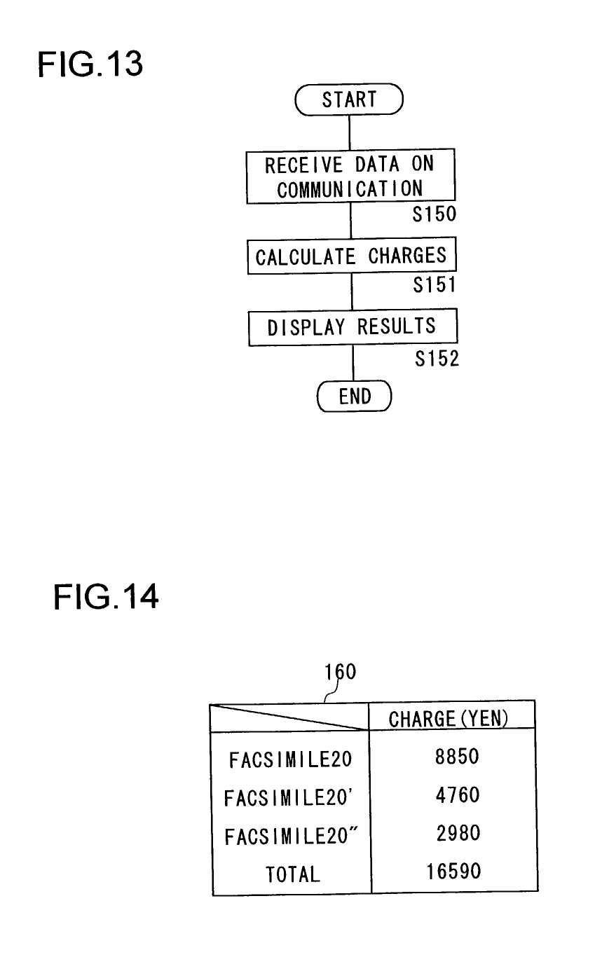

In Example 3, the cost management system 40 manages communication charges. FIG. 13 shows a flow chart of the operation of the PC 30′. First, in step S150, the PC 30′ receives data relating to communication from the facsimile device 20. Then, in step S151, based on the received data, the PC controller 31′ calculates communication charges. Then, in step S152, the calculated results are displayed on the display 34′. In similar manners, the communication charges incurred in the facsimile machines 20′ and 20″ are calculated and displayed together.

For example, in a case where the dates and times when data was transmitted, the communication partners to which data was transmitted, and the duration of each communication session are stored in the storage 27, the PC 30′ receives the data stored in the storage 27, calculates communication charges, and displays them on the display 34′ together with the communication charges calculated from the data received from the facsimile devices 20′ and 20″ in similar manners. FIG. 14 shows an image 160 displayed on the display 34′ to indicate communication charges. The image 120 permits management personnel to manage on a collective basis the communication charges incurred in the individual facsimile devices.

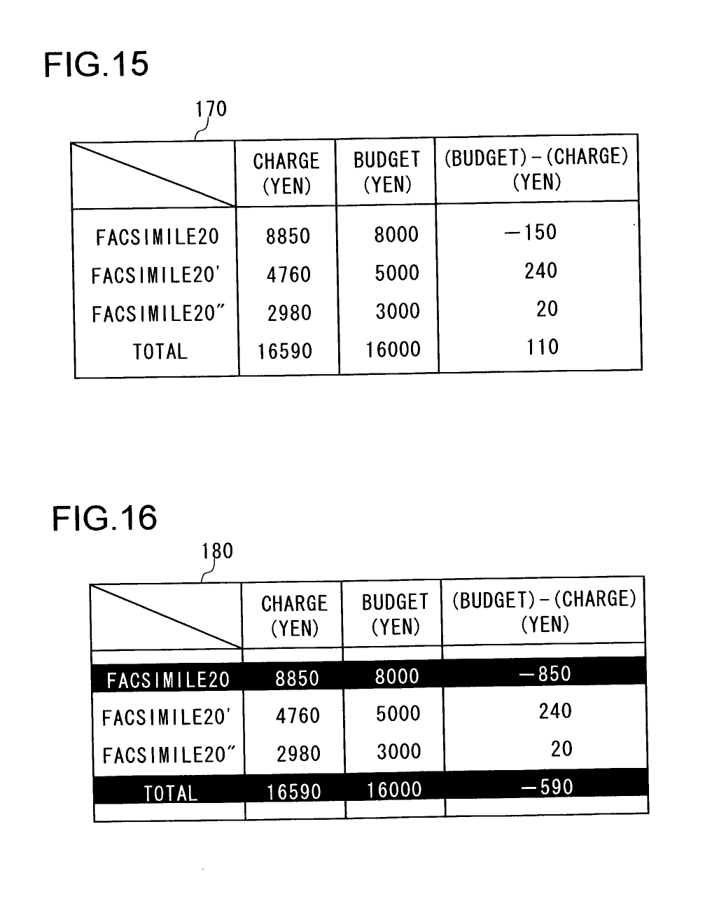

The actual communication charges calculated may be compared with previously made budgets to display the differences. FIG. 15 shows an image 170 displayed on the display 34′ to indicate the results of the comparison. The image 170 permits management personnel to manage on a collective basis whether the communication charges are within budgets or not.

Alternatively, the actual communication charges calculated may be compared with previously made budgets to output a warning as described in Example 1 when the actual communication charges have exceeded the budgets. FIG. 16 shows an image 180 displayed on the display 34′ to indicate the comparison results and the warning. Here, the communication charge incurred in the facsimile device 20 and the total communication charge have exceeded their respective budgets, and therefore the relevant results are displayed in a reversed color as a warning. The image 180 permits management personnel to check at a glance whether communication charges are within budgets or not.

Example 3 described above deals with a case where facsimile devices are used as communication terminal devices. However, it is also possible to use instead network-ready facsimile devices, network-ready image forming devices, or telephone sets. It is assumed that, in telephone sets, communication charges include those for voice communication as well as those for data communication.

In Examples 1 to 3, images indicating the calculated results are displayed on the display 34′ of the PC 30′. However, those images may be displayed on the display of one of the facsimile devices, or displayed on a separate display device (not shown) connected to the network, or printed out by the printer of one of the facsimile devices or by a separate printer (not shown) connected to the PC.

In Examples 1 to 3, the calculated results may be compiled to output a history thereof.

In Examples 1 to 3, the PC 30′ may receive data from the facsimile device 20 at such times as are set according to the situation in which they are used, for example, when the operation section 33′ of the PC 30′ is operated to request data, at dates and times set by the user, when the facsimile device is not printing, at predetermined time intervals, etc. This permits the user to set the timing of data reception in consideration of the processing performance of the facsimile controller and the load on the communication network.

For example, in a case where data from the facsimile device 20 is received at time intervals of 200 ms, the data is received substantially on a real time basis. Thus, in this case, there is no need for the storage 27 of the facsimile device 20, and the data is stored in the storage 5′ of the PC 20′.

By operating the operation section 33′ of the PC 30′ and specifying the desired facsimile device and the starting and ending dates, it is possible to output the management information of the specified facsimile device for the specified period.

By connecting together a plurality of cost management systems according to the invention and one information processing device installed at a remote site by way of a communication network, it is possible to manage a plurality of cost management systems on a collective basis. This helps further reduce costs.

What is claimed is:

1. A cost management system including an information processing device and one or more communication terminal devices connected together by way of a communication network,
wherein the information processing device receives data relating to an expendable from at least one of said communication terminal devices and generates, based on the thus received data, management information on the expendable.

2. A cost management system as claimed in claim 1,
wherein the management information is an amount or cost of the expendable consumed.

3. A cost management system as claimed in claim 1,
wherein the information processing device or said at least one of the communication terminal devices outputs the management information.

4. A cost management system as claimed in claim 1,
wherein the information processing device or said at least one of the communication terminal devices outputs a history of the management information.

5. A cost management system as claimed in claim 1,
wherein the information processing device calculates a difference between the management information and a predetermined value, and the information processing device or said at least one of the communication terminal devices outputs the thus calculated difference.

6. A cost management system as claimed in claim 1,
wherein the information processing device calculates a difference between the management information and a predetermined value, and, when the thus calculated difference is within a predetermined range, the information processing device or said at least one of the communication terminal devices outputs a warning.

7. A cost management system including an information processing device and one or more communication terminal devices connected together by way of a communication network,
wherein the information processing device receives data relating to communication from at least one of said communication terminal devices and generates, based on the thus received data, management information on the communication.

8. A cost management system as claimed in claim 7,
wherein the management information is a charge of the communication.

9. A cost management system as claimed in claim 7,
wherein the information processing device or said at least one of the communication terminal devices outputs the management information.

10. A cost management system as claimed in claim 7,
wherein the information processing device or said at least one of the communication terminal devices outputs a history of the management information.

11. A cost management system as claimed in claim 7,
wherein the information processing device calculates a difference between the management information and a predetermined value, and the information processing device or said at least one of the communication terminal devices outputs the thus calculated difference.

12. A cost management system as claimed in claim 7,
wherein the information processing device calculates a difference between the management information and a predetermined value, and, when the thus calculated difference is within a predetermined range, the information processing device or said at least one of the communication terminal devices outputs a warning.

13. An information processing device connected to one or more communication terminal devices by way of a communication network,
wherein the information processing device receives data relating to an expendable from at least one of said communication terminal devices, generates, based on the thus received data, management information on the expendable, and outputs the thus generated management information.

14. An information processing device as claimed in claim 13,
wherein the management information is an amount or cost of the expendable consumed.

15. An information processing device connected to one or more communication terminal devices by way of a communication network,
wherein the information processing device receives data relating to communication from at least one of said communication terminal devices, generates, based on the thus received data, management information on the communication, and outputs the thus generated management information.

16. An information processing device as claimed in claim 15,
wherein the management information is a charge of the communication.
